(19) United States
(12) Patent Application Publication
(10) Pub. No.: US 2018/0285769 A1
(43) Pub. Date: Oct. 4, 2018

(54) ARTIFICIAL IMMUNE SYSTEM FOR FUZZY COGNITIVE MAP LEARNING

(71) Applicant: Business Objects Software Ltd., Dublin (IE)

(72) Inventors: Ying Wu, Maynooth (IE); Paul Pallath, Naas (IE)

(21) Appl. No.: 15/475,482

(22) Filed: Mar. 31, 2017

(51) Int. Cl. G06N 99/00; G06F 17/16; G06N 7/02

(52) U.S. Cl. CPC G06N 99/005; G06N 7/02; G06F 17/16

(57) ABSTRACT

The present disclosure involves systems, software, and computer implemented methods for learning relationships between concepts using an artificial immune system. A method includes identifying a set of concepts; determining a state value for each concept at each of a set of time points; generating an initial state and a system response; designating the system response as an antigen a clonal selection algorithm; generating a set of candidate weight matrices to be used as a population of antibodies in the clonal selection algorithm; determining a system response for each antibody; determining an affinity value for each antibody, using the system response for the antibody, the affinity value for a respective antibody representing how closely the respective antibody fits the antigen; cloning a set of antibodies based on the affinity values; repeating the cloning until a stopping point is reached; and selecting a candidate weight matrix with a highest affinity value.

### BACKGROUND

Cognitive maps can be used to model relationships between concepts when simulating a real world system. A cognitive map can include a node for each modeled concept. A relationship between two concepts can be represented as an edge that connects the two related concepts. An edge can have a weight value that represents a strength of the relationship represented by the edge. An edge can be directional. A directed edge can designate a source node and a recipient node and can represent an effect of a source concept on a recipient (e.g., affected) concept.

### SUMMARY

The present disclosure involves systems, software, and computer implemented methods for learning relationships between concepts using an artificial immune system. A method includes: identifying a set of concepts for a dynamic system, each concept having a dynamic state value for the dynamic system at a given point in time; determining a state value for each concept at each of a set of time points; generating, from the state values, an initial state and a system response; designating the system response as an antigen in an artificial immune system clonal selection algorithm; generating a set of candidate weight matrices to be used as a population of antibodies in the clonal selection algorithm, each candidate weight matrix including a set of weights which each represent the impact of a first respective concept on a second respective concept in the dynamic system; determining a system response for each antibody, using the initial state; determining an affinity value for each antibody, using the system response for the antibody, the affinity value for a respective antibody representing how closely the respective antibody fits the antigen; cloning a set of antibodies based on the affinity values; repeating the cloning until a stopping point is reached; and selecting a candidate weight matrix with a highest affinity value for use in evaluating the dynamic system.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram of an example environment for learning relationships between concepts using an artificial immune system.

FIG. 2 illustrates an example fuzzy cognitive map.

FIG. 3 is a matrix that illustrates relationships between concepts.

FIG. 4 illustrates an example graph that shows concept values over a time period.

FIG. 5 is a flowchart of an example method for initializing a fuzzy cognitive map.

FIGS. 6 and 7 are flowcharts of example methods for optimizing a weight matrix.

FIG. 8 is a flowchart of an example method for applying fuzzy cognitive mapping.

### DETAILED DESCRIPTION

A Fuzzy Cognitive Map (FCM) is a type of cognitive map that includes nodes representing concepts and weighted edges representing relationships between concepts. A concept in a FCM can be an entity that produces or otherwise has an associated value. A concept can be a parameter for a device, such as a reading of a sensor output, for example. A dynamic system can include a set of concepts that each have an associated value at a given point in time.

In a FCM, edge weights can have a value between negative one and positive one. As such, a FCM is an example of fuzzy logic, in which weights representing concept relationships can be any real number between zero and one (or between zero and negative one) rather than strictly zero or one as for truth values in binary systems. Fuzzy cognitive maps can be used for modeling and simulation of dynamic systems. A given system can be represented in a FCM as a collection of concepts and weighted cause-effect dependencies. In other words, a FCM can be depicted as a fuzzy causal graph that consists of nodes and edges, in which the nodes represent concepts, and the weighted edges between the concepts represent knowledge about associations between the concepts.

Advantageous properties of FCMs, such as simplicity, support for inconsistent knowledge, support for fuzzy reasoning, causalities for knowledge modeling, and inference and learning capabilities, can make FCMs applicable to numerous research and industrial areas, such as political science, decision making, strategic planning, classification, prediction, automated control problems, modeling of software development projects, business analysis, and many others. The graph structure of FCMs can allow for static analysis, and an execution model can be applied for dynamic analysis of a modeled system. A FCM can be represented as a matrix, for example, as described in more detail below.

Different approaches can be used for developing a FCM. Developing a FCM can include determination of edge weights, for example. FCMs can be developed using expert-based methods. Expert-based methods can use domain knowledge from human experts to develop a FCM. However, expert-based methods can suffer from several drawbacks. An expert-based method relies on experts' individual knowledge and experience, so accordingly, experts who develop a FCM have to understand the entire knowledge model under consideration. As knowledge models for complex domains grow larger, a manual, expert-based approach becomes more difficult, as it becomes more difficult for a human expert to understand all of the relationships between concepts in the complex domain. As another example, different experts can have different opinions and may not agree how to generate a FCM for a particular domain. As yet another example, an expert-based method can have a potential uncontrollable convergence to undesired states and these undesired states could deviate from the expected states or actual states in a real application. Undesired states can result in a failure of generating a correct FCM. An expert can manually attempt to determine an optimal weight matrix by defining a set of learning rules as part of a mathematical model for describing how a system changes over time. Deriving learning rules can be challenging, especially for large, complex systems. Further, persons without significant experience in a particular system are unable to generate such FCMs.

Computational methods, which can be referred to as inductive methods, can be used to support or replace expert-based methods, in order to solve drawbacks of expert-based methods. Computational methods may not require human intervention after initiation, and may therefore be able to be completed in less time and with less effort as compared to expert-based methods. Computational methods can develop high-quality FCMs using historical data, and can generate a result without an expert or other user having to understand the entire knowledge model under consideration. A computational method may generate a more accurate FCM than an expert method due to avoiding human error or misunderstanding.

A computational approach for developing a FCM can be based on an Artificial Immune System (AIS). Artificial immune systems are a class of computationally intelligent, rule-based machine learning systems inspired by the principles and processes of the vertebrate immune system. The algorithms are typically modeled after the immune system's characteristics of learning and memory for use in problem solving. An AIS can be inspired by biological human immune systems whose main goal is to protect the human body from attack by foreign pathogens such as viruses, fungi, or other parasites. A foreign substance can be referred to as an antigen. An immune system can generate antibodies, which are substances that combat the antigens. In an immune system, a clonal section algorithm selects antibodies that have greater and greater affinity with an antigen over time. As described below, for development of a FCM, an adaptation of a clonal selection algorithm can be used to automatically determine weights for the FCM, using historical data, without depending on human expert knowledge, additional human input, or further human interactions.

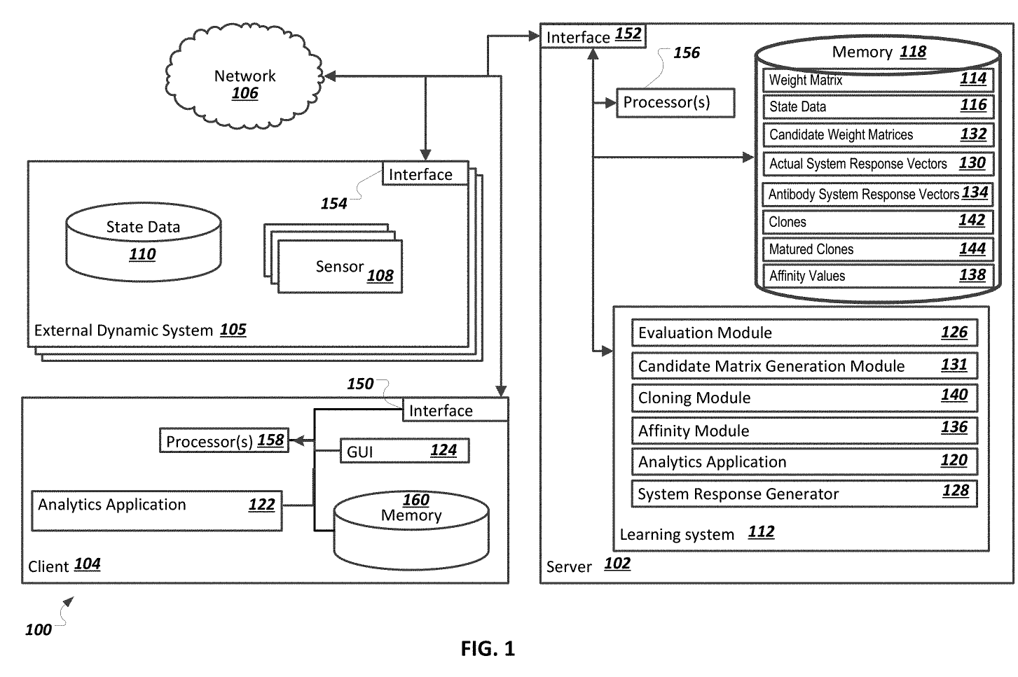

FIG. 1 is a block diagram illustrating an example system 100 for learning relationships between concepts using an artificial immune system. Specifically, the illustrated system 100 includes or is communicably coupled with a server 102, a client device 104, one or more external dynamic systems including an external dynamic system 105, and a network 106. Although shown separately, in some implementations, functionality of two or more systems or servers may be provided by a single system or server. In some implementations, the functionality of one illustrated system or server may be provided by multiple systems or servers.

The external dynamic system 105 can include various components which each output one or more data values. Each component or subcomponent of the external dynamic system 105 that outputs a value can be referred to as a concept. A concept can be a parameter for a device, such as a reading of a sensor output from a sensor 108, for example. Each concept can have an associated value at a given point in time. State data 110 is a collection of concept values for the external data system 105 that have been collected over a period of time.

A learning system 112 included in the server 102 can automatically generate a weight matrix 114 that represents relationships between the concepts of the external dynamic system 105 using the state data 110. In some implementations, the learning system 112 obtains the state data 110 in real time from the external dynamic system 105 during evaluation (either as a collection of data previously stored at the external dynamic system 105 or as a stream of state data as produced by the external dynamic system during evaluation). In other implementations, previously obtained state data 116, which can be a copy of the state data 110, is retrieved from memory 118 during evaluation. The server 102 can be a standalone system, and an evaluator user can use an analytics application 120 installed on the server to initiate and view results of the evaluation. As another example, the evaluator user can use an analytics application 122 installed on the client 104 in a client-server setup, and can initiate and view results of the evaluation using a GUI 124 of the client device 104.

The weight matrix 114 can be automatically generated for the external dynamic system 105 by an evaluation module 126 that executes an AIS clonal selection algorithm. The evaluation module 126 can identify a set of concepts for the external dynamic system that are to be included in the weight matrix 114. For example, an expert or other user who is familiar with the external dynamic system 105 can provide the set of concepts to the learning system 112, such as by using an interface of the analytics application 120 or the analytics application 122.

The evaluation module 126 can determine, from the state data 110 or state data 116, a state value for each concept at each of a set of time points. The evaluation module 126 can determine an initial state from the state data 110 or state data 116. A system response generator 128 can collect actual system response vectors 130 that represent changes to the external dynamic system 105 that have occurred at subsequent time points after a time point associated with an initial state. As described below, in some implementations, when applying the trained FCM model, one initial state vector is identified as an initial state. In other implementations, when training the FCM, multiple initial state vectors are identified to form {initial vector, system response} pairs, where each initial state vector is treated as an initial state for a corresponding system response vector.

The evaluation module 126 can treat the actual system response vectors 130 as an antigen in the clonal selection algorithm. A candidate matrix generation module 131 can generate a set of candidate weight matrices 132 that can be evaluated for potential selection as the weight matrix 114. The candidate weight matrices 132 can be treated as antibodies in the clonal selection algorithm. The system response generator 128 can calculate an antibody system response vector 134 for each respective candidate weight matrix 132 that represents estimated changes to the state of the external dynamic system 105 over time as calculated using the respective candidate weight matrix 132.

An affinity module 136 can calculate affinity values 138 for the candidate weight matrices 132, with each affinity value 138 representing how closely a given candidate weight matrix 132 leads to the actual system response vectors 130 (e.g., fits the antigen). The affinity module 136 can determine a set of candidate weight matrices 132 that have highest affinity values. An affinity value can be calculated for each antibody in the affinity module 136, with each affinity value indicating how closely a given antibody fits to the antigen.

A cloning module 140 can clone the candidate weight matrices that have highest affinity values to create a population of clones 142. The affinity calculator 136 can perform an affinity calculating process on the population of clones 142 so that the cloning module 140 can create a population of matured clones 144. The matured clones 144 can be mutations of the original population of clones 142. The affinity calculator 136 can calculate an affinity value 138 for each matured clone 144 that represents how closely a given matured clone 144 fits the antigen. The affinity calculator 136 can determine a set of matured clones 144 that have highest affinity values. The evaluation module 126 can replace candidate weight matrices 132 that have lowest affinity values with the matured clones 144 that have the highest affinity values to create an updated population of candidate weight matrices 132.

The evaluation module 126 can determine whether the highest affinity value of the candidate weight matrices 132 is greater than a predetermined threshold. If the highest affinity value of the candidate weight matrices 132 is greater than the predetermined threshold, the candidate weight matrix 132 with the highest affinity value can be selected as the weight matrix 114. If the highest affinity value of the candidate weight matrices 132 is not greater than the predetermined threshold, the evaluation module 126 can perform another evaluation iteration using the updated population of candidate weight matrices 132, including cloning and maturing of candidate weight matrices 132 that have the highest affinity values. The evaluation module 126 can iterate until a candidate weight matrix 132 has an affinity value that is greater than the predefined threshold, until a predefined number of iterations is reached, or until the change of the highest affinity values between iterations is below a predefined threshold.

The selected weight matrix 114 can be used for evaluation of the external dynamic system 105, such as for simulating future state values of concepts of the external dynamic system 105. A user can use the analytics application 120 and/or the analytics application 122 to simulate the external dynamic system 105 using a FCM that is based on the weight matrix 112, for example. For example, the external dynamic system 105 can be an IoT (Internet of Things) system, with multiple sensors. A generated FCM can assist with predictive maintenance, where the underlying impact among sensors can be modelled in a FCM to understand future repair and replacement considerations.

As used in the present disclosure, the term “computer” is intended to encompass any suitable processing device. For example, although FIG. 1 illustrates a single server 102 and a single client device 104, the system 100 can be implemented using a single, stand-alone computing device, two or more servers 102, or two or more client devices 104. Indeed, the server 102, the external dynamic system 105, and the client device 104 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102 and the client device 104 may be adapted to execute any operating system, including Linux, UNIX, Windows, Mac OS®, Java™, Android™, iOS or any other suitable operating system. According to one implementation, the server 102 may also include or be communicably coupled with an e-mail server, a Web server, a caching server, a streaming data server, and/or other suitable server.

Interfaces 150, 152, and 154 can be used by the client device 104, the server 102, and the external dynamic system 105, respectively, for communicating with other systems in a distributed environment—including within the system 100—connected to the network 106. Generally, the interfaces 150, 152, and 154 each comprise logic encoded in software and/or hardware in a suitable combination and operable to communicate with the network 106. More specifically, the interfaces 150, 152, and 154 may each comprise software supporting one or more communication protocols associated with communications such that the network 106 or interface's hardware is operable to communicate physical signals within and outside of the illustrated system 100.

The server 102 includes one or more processors 156. Each processor 156 may be a central processing unit (CPU), a blade, an application specific integrated circuit (ASIC), a field-programmable gate array (FPGA), or another suitable component. Generally, each processor 156 executes instructions and manipulates data to perform the operations of the server 102. For example, each processor 156 executes the functionality required to receive and respond to requests from the client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The server 102 includes the memory 118. In some implementations, the server 102 includes multiple memories. The memory 118 may include any type of memory or database module and may take the form of volatile and/or non-volatile memory including, without limitation, magnetic media, optical media, random access memory (RAM), read-only memory (ROM), removable media, or any other suitable local or remote memory component. The memory 118 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server 102.

The client device 104 may generally be any computing device operable to connect to or communicate with the platform server 102 via the network 106 using a wireline or wireless connection. In general, the client device 104 comprises an electronic computer device operable to receive, transmit, process, and store any appropriate data associated with the system 100 of FIG. 1. The client device 104 can include one or more client applications, including the analytics application 122. A client application is any type of application that allows the client device 104 to request and view content on the client device 104. In some implementations, a client application can use parameters, metadata, and other information received at launch to access a particular set of data from the server 102. In some instances, a client application may be an agent or client-side version of the one or more enterprise applications running on an enterprise server (not shown).

The client device 104 further includes one or more processors 158. Each processor 158 included in the client device 104 may be a central processing unit (CPU), an application specific integrated circuit (ASIC), a field-programmable gate array (FPGA), or another suitable component. Generally, each processor 158 included in the client device 104 executes instructions and manipulates data to perform the operations of the client device 104. Specifically, each processor 158 included in the client device 104 executes the functionality required to send requests to the server 102 and to receive and process responses from the platform server 102.

The client device 104 is generally intended to encompass any client computing device such as a laptop/notebook computer, wireless data port, smart phone, personal data assistant (PDA), tablet computing device, one or more processors within these devices, or any other suitable processing device. For example, the client device 104 may comprise a computer that includes an input device, such as a keypad, touch screen, or other device that can accept user information, and an output device that conveys information associated with the operation of the server 102, or the client device 104 itself, including digital data, visual information, or the GUI 124.

The GUI 124 of the client device 104 interfaces with at least a portion of the system 100 for any suitable purpose, including generating a visual representation of the analytics application 122. In particular, the GUI 124 may be used to view a FCM, various Web pages, or other user interfaces. Generally, the GUI 124 provides the user with an efficient and user-friendly presentation of business data provided by or communicated within the system. The GUI 124 may comprise a plurality of customizable frames or views having interactive fields, pull-down lists, and buttons operated by the user. The GUI 124 contemplates any suitable graphical user interface, such as a combination of a generic web browser, intelligent engine, and command line interface (CLI) that processes information and efficiently presents the results to the user visually.

Memory 160 included in the client device 104 may include any memory or database module and may take the form of volatile or non-volatile memory including, without limitation, magnetic media, optical media, random access memory (RAM), read-only memory (ROM), removable media, or any other suitable local or remote memory component. The memory 160 may store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 104.

There may be any number of client devices 104 associated with, or external to, the system 100. For example, while the illustrated system 100 includes one client device 104, alternative implementations of the system 100 may include multiple client devices 104 communicably coupled to the server 102 and/or the network 106, or any other number suitable to the purposes of the system 100. Additionally, there may also be one or more additional client devices 104 external to the illustrated portion of system 100 that are capable of interacting with the system 100 via the network 106. Further, the term “client”, “client device” and “user” may be used interchangeably as appropriate without departing from the scope of this disclosure. Moreover, while the client device 104 is described in terms of being used by a single user, this disclosure contemplates that many users may use one computer, or that one user may use multiple computers.

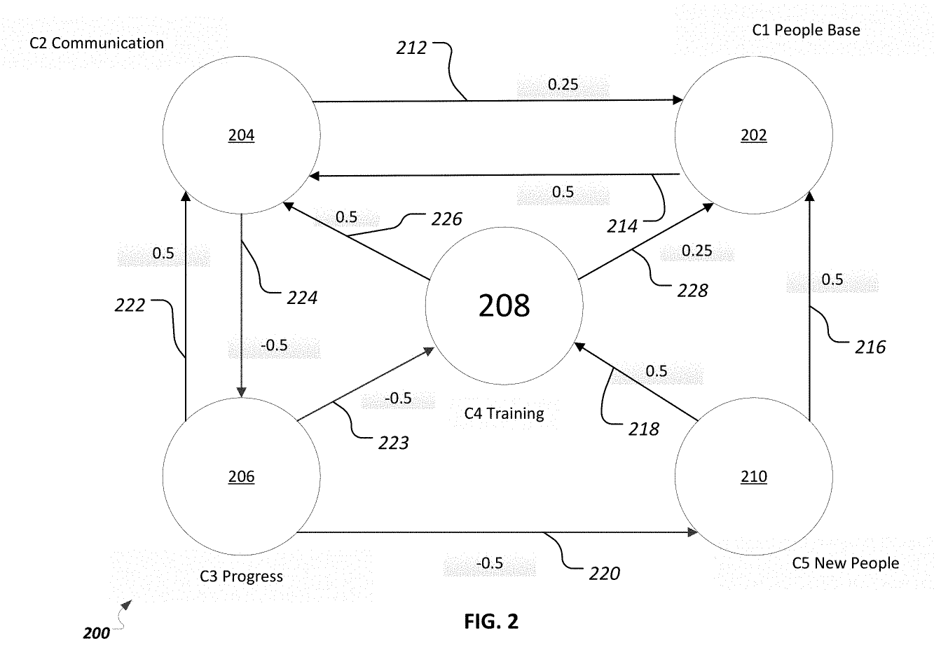

FIG. 2 illustrates an example fuzzy cognitive map 200. The FCM 200 illustrates relationships between concepts for a software project. A C1 concept 202 relates to a base of people, a C2 concept 204 relates to communication, a C3 concept 206 relates to progress, a C4 concept 208 relates to training, and a C5 concept 210 relates to new people. If one concept affects another concept, an arrow connecting the affecting concept to the affected concept can be included in the FCM 200. If the affected concept also affects the affecting concept, a second arrow can be drawn between the two concepts in the opposite direction of the first arrow. For example, an arrow 212 indicates that the C2 concept 204 relating to communication affects the C1 concept 202 relating to the base of people. An arrow 214 indicates that the C2 concept 202 relating to the base of people affects the C2 concept 204 of communication.

Other relationships between concepts are represented by other arrows on the FCM 200. For example, an arrow 216 represents an effect of the C5 concept relating to new people on the C1 concept relating to the base of people. An arrow 218 represents an effect of the C5 concept relating to new people on the C4 concept 208 relating to training. An arrow 220 represents an effect of the C3 concept 206 related to progress on the C5 concept 210 relating to new people. An arrow 222 represents an effect of the C3 concept 206 related to progress on the C2 concept 204 relating to communication. An arrow 223 represents an effect of the C3 concept 206 related to progress on the C4 concept 208 relating to training. An arrow 224 represents an effect of the C2 concept relating to communication on the C3 concept 206 relating to progress. An arrow 226 represents an effect of the C4 concept 208 relating to training on the C2 concept 204 relating to communication. An arrow 228 represents an effect of the C4 concept 208 relating to training on the C1 concept 202 relating to the base of people.

A numerical weight presented and associated with a respective arrow can indicate a strength and type of an effect of an affecting concept on an affected concept. In some implementations, weight values are defined to be within a range of −1.0 to 1.0. Positive weights can represent a positive effect, meaning that if a value of an affecting concept goes up, a value of the affected concept also goes up, and if the value of the affecting concept goes down, the value of the affected concept also goes down. A weight of 1.0 may indicate that an increase to an affecting concept will cause a same amount of increase in the affected concept. A weight of 0.25 associated with the arrow 212 may indicate that a change in a value for the C2 concept 204 of communication will cause an increase equal to four times that change in a value for the C1 concept 202. As another example, a weight of 0.5 associated with the arrow 222 may indicate that a change in value for the C3 concept 206 will cause an increase equal to two times that change in a value for the C2 concept 204.

Negative weights can represent a negative effect, meaning that if a value of an affecting concept goes up, the value of an affected concept goes down, and if the value of an affecting concept goes down, the value of an affected concept goes up. For example, a weight of −0.5 associated with the arrow 220 indicates that if a value for the C3 concept 206 relating to progress goes up, a value for the C5 concept 210 relating to new people goes down.

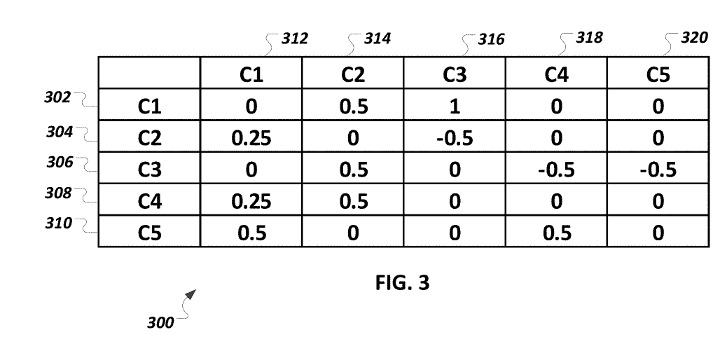

FIG. 3 is a matrix 300 that illustrates relationships between concepts. The entries in the matrix 300 correspond to the weights on the FCM 200 described above with respect to FIG. 2. The matrix 300 includes rows 302, 304, 306, 308, and 310 and columns 312, 314, 316, 318, and 320 corresponding to the concepts C1, C2, C3, C4, and C5, respectively. For a given row for a given concept, if the given concept affects another concept, a non-zero value is included in the column corresponding to the affected concept. For example, as shown in the row 302, values of 0.5 and 1 are respectively included in the columns for C2 and C3 in the row 302, which indicates that the C1 concept affects the C2 and C3 concepts. A value of zero is included in the row 302 in the columns for the C4 and C5 concepts, indicating that the C1 concept does not affect the C4 and C5 concepts.

Similarly, for a given column for a given concept, if the given concept is affected by another concept, a non-zero value will be included in the row corresponding to the affecting concept. For example, as shown in the column 312, values of 0.25, 0.25, and 0.5 are respectively included in the rows 304, 306, and 310 for the C2, C3, and C5 concepts in the column 312, which indicates that the concepts C2, C3, and C5 affect the C1 concept. A value of zero for the C3 concept in the column 312 indicates that the C3 concept does not affect the C1 concept.

The matrix 300 can be initially populated, for example, by a human expert who has domain knowledge in the C1, C2, C3, C4, and C5 concepts. The expert can assign a weight value to each pair of concepts based on the expert's understanding of the domain. As another example and as described in more detail below, the matrix 300 can be populated programmatically using an algorithm, such as a clonal section algorithm of an AIS.

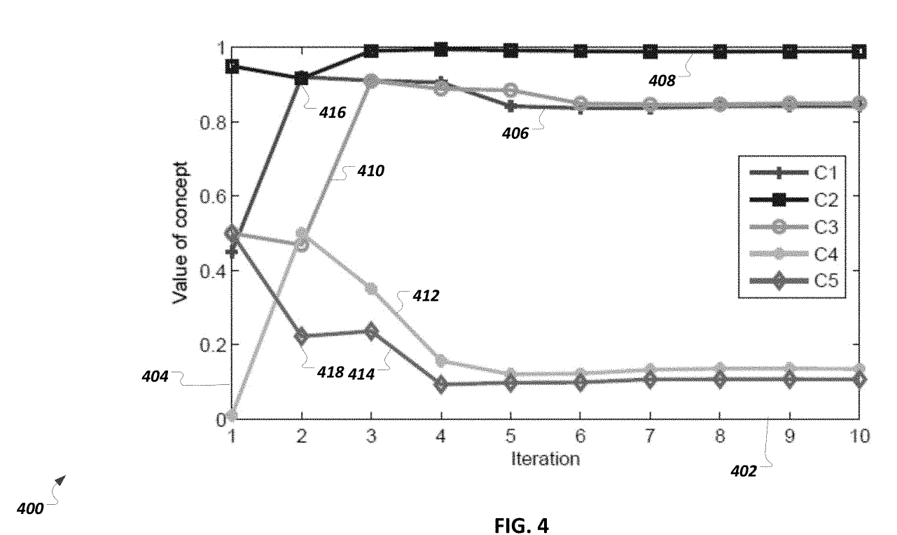

FIG. 4 illustrates an example graph 400 that shows concept values over a time period. The graph 400 includes an X axis 402 representing time points at which values have been determined for a set of concepts. A Y axis 404 represents values that have been determined for the time points. Lines 406, 408, 410, 412, and 414 respectively correspond to C1, C2, C3, C4, and C4 concepts.

The points on the graph 400 can be calculated using an initial value for each concept and the FCM 200 of FIG. 2 or the matrix 300 of FIG. 3. A state value for a concept Cᵢ at time t can be denoted as Aᵢ^{(t)}. The state of the FCM at a time t can be described by a vector A^{(t)}=[A₁^{(t)}, . . . , A_{N}^{(t)}]. For example, as shown in the graph 400, at a time t=0, the state of the FCM can be described as a vector [0.45, 0.95, 0.5, 0.01, 0.5] which represents the initial states for the C1, C2, C3, C4, and C5 concepts. A calculation of a next state value of a Cᵢ concept at time t+1, denoted as Aᵢ^{(t+1)}, can be calculated using formula (1)

$${A}_{i}^{( t + 1 )} = f ( {\sum }_{{j \neq i}_{j = 1}}^{N} {A}_{j}^{( t )} \cdot {w}_{ji}^{( t )} ) , \qquad ( 1 )$$

where wⱼᵢ^{(t)} is the weight of the interconnection between concept Cⱼ and concept Cᵢ at time t and f(x) is a sigmoid function which can be used to restrict an unbounded weight sum to a certain range, such as 0 to 1.0. An example sigmoid function is shown in formula (2)

$$f ( x ) = \frac{1}{1 + {e}^{- λ x}} \qquad ( 2 )$$

where λ is a positive constant, such as 5.0, and f(x) lies between zero and one.

The graph 400 can illustrate potential dependencies between concepts. For example, as shown by points 416 and 418, when a value for the C1 concept increased, a value for the C5 concept decreased. The graph 400 also illustrates that the dynamic system represented by the FCM reached a steady state (e.g., concepts maintaining a current state value) by the tenth time point. Some dynamic systems can reach a steady state after a certain period of time. For example, a system related to a chemical reaction may undergo changes during the reaction but may reach a steady state after a period of time elapses.

As describe above, a weight matrix for a FCM can be determined manually by one or more experts or can be determined automatically by an algorithm. An adaptation of an AIS clonal selection algorithm can be used to identify underlying causal relationships among concept nodes of a FCM so that the FCM can be used to simulate the behavior of the dynamic system. The clonal selection algorithm can use as input observed state values of concepts at successive time points.

For a system with N concepts, with observations taken at K time points, the state value input can be a K×N matrix, with each row, given as A^{(t)}=[A₁^{(t)}, . . . , A_{N}^{(t)}], where t=0, 1, . . . , K−1, corresponding to the state of the FCM model at time t. The clonal selection algorithm can be configured to find an optimal weight matrix for the FCM model, representing the cause-effect relationships among concepts, to minimize the difference between the desired (e.g., observed) value of each concept node and a value determined based on the determined optimal weight matrix. In other words, the clonal selection algorithm can be configured to determine the values of N² parameters in the optimal weight matrix that take values from the range [−1.0, 1.0].

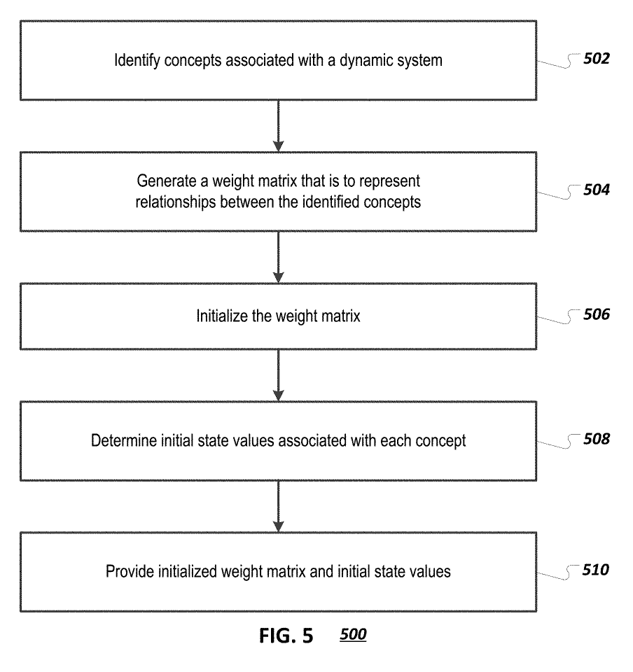

The clonal selection algorithm can be configured to use response sequences of the dynamic system as antigens and a set of antibodies that includes a set of candidate weight matrices. Affinity values can be calculated for each antibody that each represent how closely a given antibody fits the antigen. Antibodies with the relatively highest affinities can be selected and cloned. Clones can be matured through an affinity maturation process to create matured clones. Of those selected antibodies with the highest affinities, antibodies with relatively higher affinities can be mutated more and antibodies with lower affinities can be mutated to a lesser degree. Matured clones that have the highest affinities can replace antibodies with low affinities in the population of antibodies to create a new population of antibodies for a next iteration of the clonal selection algorithm. Eventually, an antibody (e.g., a candidate weight matrix) with a highest affinity can be selected as an optimal, automatically learned weight matrix, for use with the dynamic system. The clonal selection algorithm is described in more detail below with respect to FIGS. 5-8.

FIG. 5 is a flowchart of an example method 500 for initializing a fuzzy cognitive map. It will be understood that method 500 and related methods may be performed, for example, by any suitable system, environment, software, and hardware, or a combination of systems, environments, software, and hardware, as appropriate. For example, one or more of a client, a server, or other computing device can be used to execute method 500 and related methods and obtain any data from the memory of the client, the server, or the other computing device. In some implementations, the method 500 and related methods are executed by one or more components of the system 100 described above with respect to FIG. 1. For example, the method 500 and related methods can be executed by the learning system 112 of FIG. 1.

At 502, a set of concepts associated with a dynamic system are identified. As described above, a concept is an aspect of the dynamic system that generates or otherwise has an associated value at a given point in time.

At 504, a weight matrix is generated that represents relationships between the identified concepts. The weight matrix can be a table data structure, for example. The weight matrix can include a row and a column for each concept (e.g., if N concepts have been identified, the weight matrix can include N rows and N columns).

At 506, the weight matrix is initialized. For example, random values can be stored in the weight matrix. In some implementations, a weight matrix cell that is associated with a same row and column number can be initialized to zero. A zero weight can represent that a given concept does not affect itself. The random values used for the other cells of the matrix can be restricted to be between −1.0 to 1.0. The initialization of the weight matrix at 506 can be optional in FCM training of an AIS, as candidate weight matrices can be randomly generated in the AIS algorithm.

At 508, initial state values associated with each concept are determined. The initial state values can be determined by observing the dynamic system at a particular point in time, for example. As another example, the initial state values can be determined by identifying a data source that includes stored state values and identifying an initial set of state values in the data source.

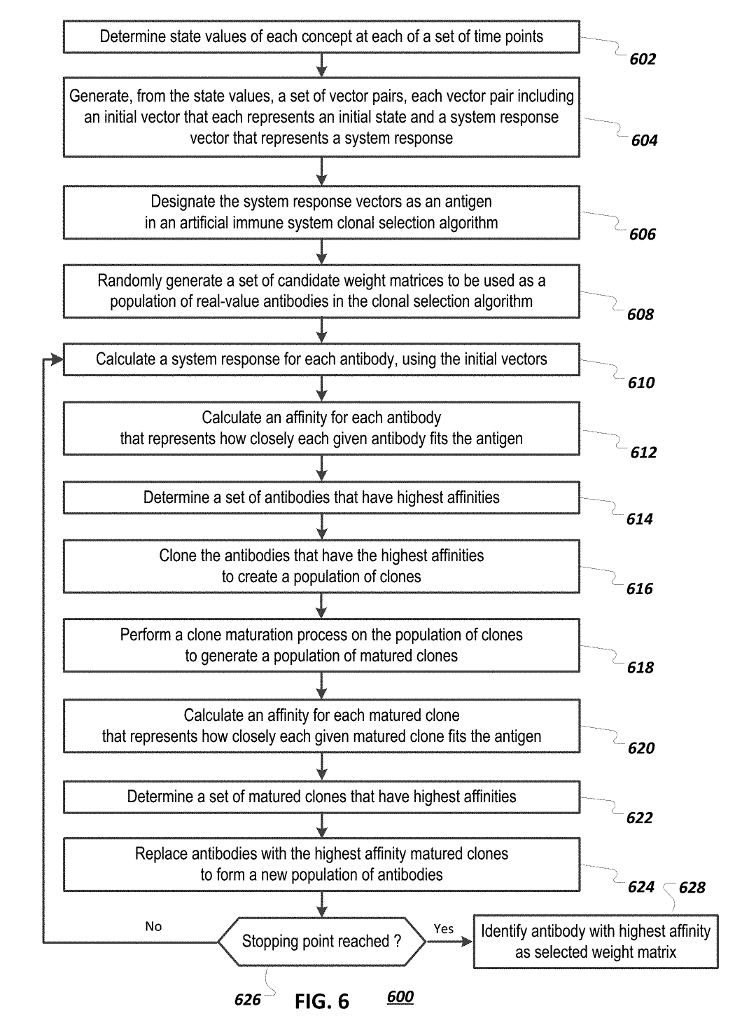

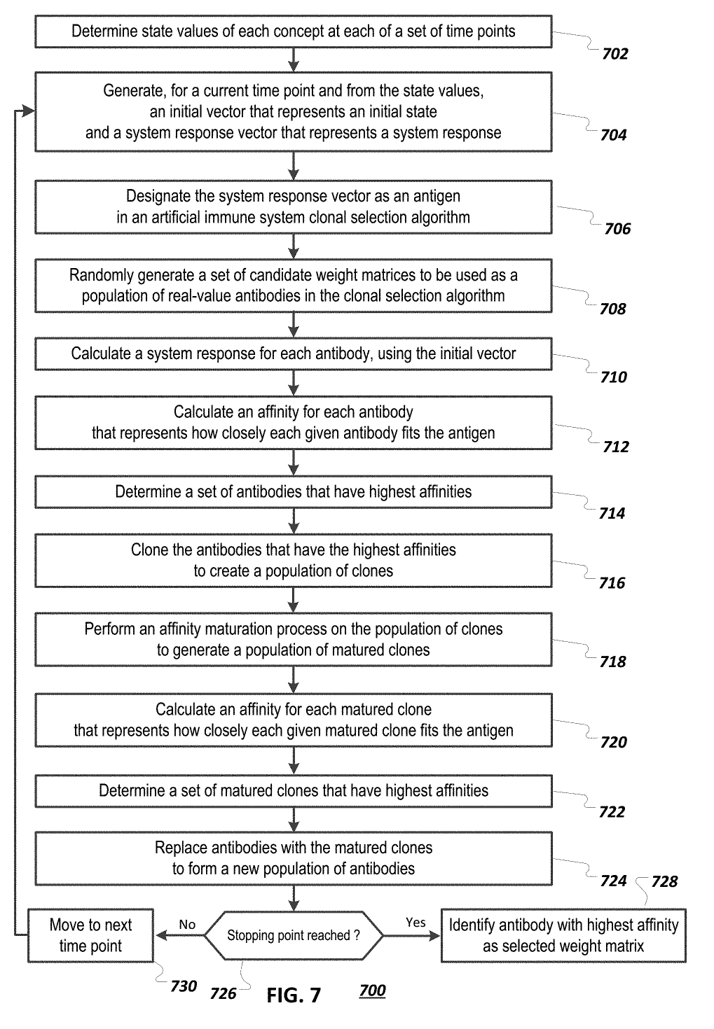

At 510, the initialized weight matrix and initial state values are provided as an input for another process, such as the method 600 described below with respect to FIG. 6 or the method 700 described below with respect to FIG. 7.

FIG. 6 is a flowchart of an example method 600 for optimizing a weight matrix. It will be understood that method 600 and related methods may be performed, for example, by any suitable system, environment, software, and hardware, or a combination of systems, environments, software, and hardware, as appropriate. For example, one or more of a client, a server, or other computing device can be used to execute method 600 and related methods and obtain any data from the memory of the client, the server, or the other computing device. In some implementations, the method 600 and related methods are executed by one or more components of the system 100 described above with respect to FIG. 1. For example, the method 600 and related methods can be executed by the learning system 112 of FIG. 1.

At 602, a state value is determined for each concept of a dynamic system at each of a set of time points. The time points can be represented as t=1, 2, . . . , K. The state values can be obtained from an external dynamic system or can be retrieved from data previously obtained or associated with the dynamic system.

At 604, a set of vector pairs is generated from the state values. Each vector pair includes an initial vector that represents an initial state for a given time point and a desired system response vector that represents a system response for the next time point. The state values at a time point t, A^{(t)}, can be an initial vector and the state values at the next time point t+1, A^{(t+1)}, can be a system response vector. A total of K−1 pairs of states can be generated with each state pair in a form of {initial vector, system response vector}.

At 606, the system response vectors are designated as an antigen Ag in an artificial immune system clonal selection algorithm. At 608, a set of N candidate weight matrices are randomly generated. The set of candidate weight matrices are to be used as a population of real-value antibodies Ab in the clonal selection algorithm. As described below, the clonal selection algorithm can be configured to determine an antibody, e.g., a particular candidate weight matrix, that most closely fits the antigen, e.g., the system response vectors. An alternative possible approach for generating candidate weight matrices can be based on an initial investigation of underlying relationships among concepts. Specifically, the underlying relationships of concepts can be initially identified by building a stepwise linear regression model respectively for each concept where the rest of the concepts are used as input variables. With each regression model, key influencing input concepts that have a strong relationship with the target concept can be analyzed and the coefficients of those input concepts can be used to initialize the weight matrix, which can provide a starting point for optimization.

At 610, a system response is calculated for each antibody, using the initial vectors. The initial vectors can be denoted as A^{(t)}. The calculated system responses can be denoted as Â^{(t)}. The system responses can be calculated using formulas (1) and (2) described above with respect to FIG. 4.

At 612, an affinity value is calculated for each antibody. The affinity value for an antibody represents how closely the antibody fits the antigen. The affinity value for an antibody can be based on a difference between the system response generated using the antibody (e.g., using a current candidate weight matrix) and a desired system response. The difference between the system response and the desired system response for an antibody Ab can be determined using formula (3):

$$DF ( Ab ) = \frac{1}{( K - 1 ) \cdot N} {\sum }_{t = 1}^{K - 1} {‖ {A}^{( t )} - {\hat{A}}^{( t )} ‖}^{2} \qquad ( 3 )$$

where K is the number of desired system responses, A^{(t)} is the desired system response from the A^{(t-1)} initial vector (which represents the system state at time point t), and Â^{(t)} is the system response.

The affinity of an antibody Ab can be determined using formula (4):

$$S ( Ab ) = \frac{1}{10000 \cdot DF ( Ab ) + 1} \qquad ( 4 )$$

where DF(Ab) is determined using formula (3). The set of determined affinity values can be stored in an affinity vector f.

At 614, a set of antibodies that have highest affinities is determined. For example, n antibodies having a top n highest affinity values can be determined, where n is a positive integer. As another example, the antibodies having affinity values that are more than a threshold affinity value can be determined.

At 616, the n antibodies that have the highest affinities are cloned to create a population of clones. The population of clones can be referred to as a repertoire and can be denoted as C. Each of the n antibodies can be cloned independently and proportionally according to a respective antigenic affinity. The higher the antigenic affinity of an antibody, the higher the number of clones generated for the antibody. The number of clones for each antibody in Ab_{{n}} can be calculated as round (β×N), where β∈(0,1) is a predefined parameter to control the size of clones from one antibody. A total number of clones can be calculated as n×round(β×N).

At 618, a clone maturation process is performed on the population of clones to generate a population of matured clones. Each clone can be matured by a calculation using formula (5):

c′ᵢⱼ=cᵢⱼ+α exp(−fᵢ)μ (5)

where μ can be drawn from a Gaussian distribution with zero mean and unit variance, μ˜N(0,1), cᵢⱼ is defined as the j^{th} clone of the i^{th} parent antibody, and fᵢ is the i^{th} affinity vector.

At 620, an affinity value is calculated for each matured clone, using the vector pairs. The affinity value for a matured clone represents how closely the matured clone fits the antigen. Affinity values can be determined as described above for step 612.

At 622, a set of n matured clones that have the highest affinities is determined. For example, n matured clones having a top n highest affinity values can be determined, where n is a positive integer. As another example, the matured clones having affinity values that are more than a threshold affinity value can be determined.

At 624, antibodies are replaced with the set of matured clones that have the highest affinities to form a new population of antibodies. Antibodies that have lowest affinity values can be replaced by the set of matured clones that have the highest affinity values. The set of matured clones that have the highest affinity values can be antibodies in a next iteration of the method 600.

At 626, a determination is made as to whether a stopping point has been reached. For example, a stopping point can be that a highest antibody affinity value is greater than a predetermined threshold or the number of iterations is reached or the change of the highest affinity values between iterations is below a predefined threshold.

At 628, if a stopping point has been reached, the antibody with the highest affinity value is identified as a selected weight matrix, for use in one or more applications associated with the dynamic system.

If a stopping point has not been reached (e.g., a highest antibody affinity value is not greater that the predetermined threshold), then method 600 returns to step 610 and a next iteration of method 600 is performed, using the new population of antibodies.

FIG. 7 is a flowchart of an example method 700 for optimizing a weight matrix. The method 700 is similar to the method 600. The method 600 uses pairs of initial state/system response vectors for calculation of affinity values for antibodies, which can result in an antibody being optimized iteratively, which can be viewed as a type of batch learning, where all state pairs are considered in one iteration. The method 700 optimizes the weight matrix iteratively and each iteration focuses on a single time point, meaning that one pair of states for a current time point is used to calculate affinity values for antibodies. When a new population of antibodies is generated, a current time point is moved to a next time point, and a next pair of states is used to calculate the affinity values for the new population of antibodies. The method 700 can be considered an online learning approach, where only one sate pair is considered in a given iteration.

It will be understood that method 700 and related methods may be performed, for example, by any suitable system, environment, software, and hardware, or a combination of systems, environments, software, and hardware, as appropriate. For example, one or more of a client, a server, or other computing device can be used to execute method 700 and related methods and obtain any data from the memory of the client, the server, or the other computing device. In some implementations, the method 700 and related methods are executed by one or more components of the system 100 described above with respect to FIG. 1. For example, the method 700 and related methods can be executed by the learning system 112 of FIG. 1.

At 702, a state value is determined for each concept of a dynamic system at each of a set of time points. The time points can be represented as t=1, 2, . . . , K. The state values can be obtained from an external dynamic system or can be retrieved from data previously obtained or associated with the dynamic system.

At 704, an initial vector and a system response vector are generated from the state values. The initial vector, which can be denoted A^{(t)}, represents the current state for a current time point t. The system response vector, which can be denoted A^{(t+1)}, includes actual states for a next time point t+1.

At 706, the system response vector is designated as an antigen Ag in an artificial immune system clonal selection algorithm. At 708, a set of N candidate weight matrices are randomly generated. The set of candidate weight matrices are to be used as a population of real-value antibodies Ab in the clonal selection algorithm. As described below, the clonal selection algorithm is configured to determine an antibody, e.g., a particular candidate weight matrix, that most closely fits the antigen, e.g., the system response vector.

At 710, a system response is calculated for each antibody, using the initial vector A^{(t)}. The calculated system responses can be denoted as Â^{(t)}. The system responses can be calculated using formulas (1) and (2) described above with respect to FIG. 4.

At 712, an affinity value is calculated for each antibody Abᵢ. The affinity value for an antibody represents how closely the antibody fits the antigen. The affinity for an antibody can be calculated using formula (4) described above with respect to FIG. 6. A difference calculation included in formula (4) can be determined using formula (6) below:

DF(Ab)=∥A^{(t)}−Â^{(t)}∥² (6)

rather than the formula (3) as for the method 600.

At 714, a set of antibodies that have highest affinities is determined. For example, n antibodies having a top n highest affinity values can be determined, where n is a positive integer. As another example, the antibodies having affinity values that are more than a threshold affinity value can be determined.

At 716, the antibodies that have the highest affinities are cloned to create a population of clones. The population of clones can be referred to as a repertoire and can be denoted as C. Each of the n antibodies can be cloned independently and proportionally according to a respective antigenic affinity. The higher the antigenic affinity of an antibody, the higher the number of clones generated for the antibody. The number of clones for each antibody in Ab_{{n}} can be calculated as round(β×N). A total number of clones can be calculated as n×round(β×N).

At 718, an affinity maturation process is performed on the population of clones to generate a population of matured clones. Each clone can be matured by a calculation using formula (6), as described above with respect to FIG. 6.

At 720, an affinity value is calculated for each matured clone. The affinity value for a matured clone represents how closely the matured clone fits the antigen. Affinity values can be determined as described above for step 712.

At 722, a set of n matured clones that have the highest affinities is determined. For example, n matured clones having a top n highest affinity values can be determined, where n is a positive integer. As another example, the matured clones having affinity values that are more than a threshold affinity value can be determined.

At 724, antibodies are replaced with the set of matured clones that have the highest affinities to form a new population of antibodies. Antibodies that have lowest affinity values can be replaced by the set of matured clones that have the highest affinity values. The set of matured clones that have the highest affinity values can be antibodies in a next iteration of the method 700.

At 726, a determination is made as to whether a stopping point has been reached. For example, a stopping point can be that a highest antibody affinity value is greater than a predetermined threshold.

At 728, if a stopping point has been reached, an antibody with a highest affinity value is identified as a selected weight matrix, for use in one or more applications associated with the dynamic system.

At 730, if a stopping point has not been reached, a next time point is used as the current time point, and processing continues at 704.

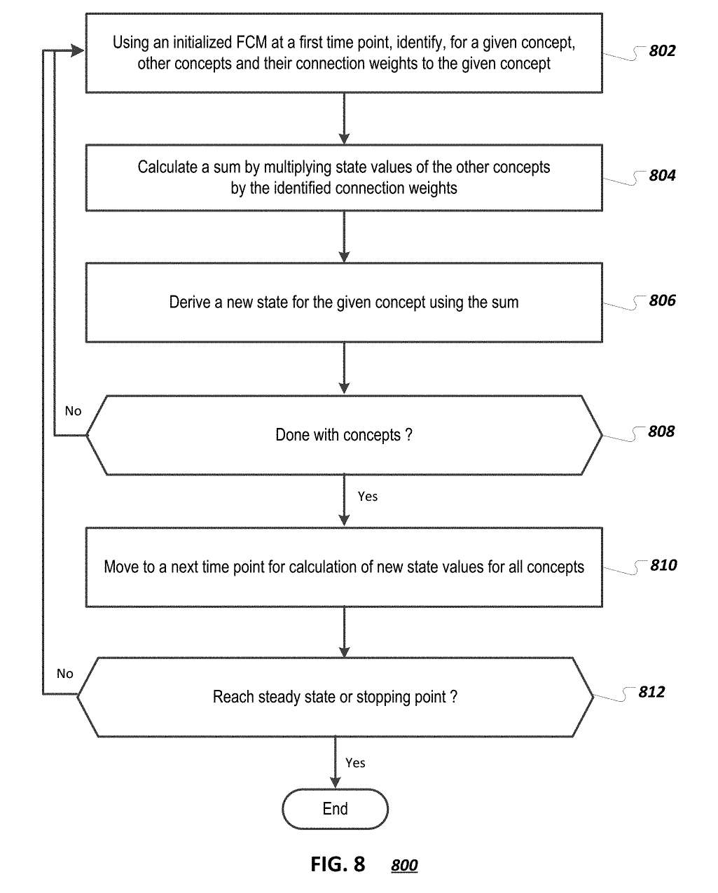

FIG. 8 is a flowchart of an example method 800 for applying fuzzy cognitive mapping. It will be understood that method 800 and related methods may be performed, for example, by any suitable system, environment, software, and hardware, or a combination of systems, environments, software, and hardware, as appropriate. For example, one or more of a client, a server, or other computing device can be used to execute method 800 and related methods and obtain any data from the memory of the client, the server, or the other computing device. In some implementations, the method 800 and related methods are executed by one or more components of the system 100 described above with respect to FIG. 1. For example, the method 800 and related methods can be executed by the learning system 112 or the analytics application 120 of FIG. 1.

At 802, an initialized FCM for a dynamic system is used, at a first time point as a current time point, to identify, for a given concept, other concepts and their connections weights to the given concept. The initialized FCM can include an optimized weight matrix optimized by the method 600 or the method 700, for example. The given concept can be a first selected concept. Other concepts can be selected as the given concept in other iterations of the method 800.

At 804, a sum is calculated by multiplying state values of the other concepts by the identified connection weights. The sum can be calculated using formula (7) below

$${\sum }_{{j \neq i}_{j = 1}}^{N} {A}_{j}^{( t )} \cdot {w}_{ji}^{( t )} \qquad ( 7 )$$

where wⱼᵢ^{(t)} is the identified weight of the interconnection between concept Cⱼ and the given concept and Aⱼ^{(t)} is the state of the j^{th} concept at the current time point.

At 806, a new state is derived for the given concept using the sum. The new state can be calculated using formula (1) and formula (2) as described above with respect to FIG. 3.

At 808, a determination is made as to whether a new state has been calculated for all of the concepts in the FCM for the current time point. If a new state has not been calculated for all of the concepts in the FCM for the current time point, the method 800 returns to 802 for a selection of a new given concept and a next iteration of the method 800.

At 810, if a new state has been calculated for each concept in the FCM for the current time point, a current time point is set to a next time point.

At 812, a determination is made as to whether a steady state or some other stopping point has been reached. A steady state can be a state of the dynamic system in which, for each concept, a current state of a given concept matches a previous state of the given concept. As another example, a steady state can be a state in which, for each concept, a current state of a given concept matches a previously determined number of multiple previous states of the given concept. For example, a steady state can be identified if each given concept's current state is the same value as the given concept's previous two states. Another type of stopping point can be when a predefined number of iterations of the method 800 have been performed for a certain number of time points.

If a stopping point has not been reached, the method returns to 802 and new state values for all of the concepts are determined for the next time point, in a next iteration of the method 800. If a stopping point has been reached, the method 800 ends. The current states of the concepts can be used for one or more applications. For example, in a chemical reaction process, a steady state may have been achieved, and the concepts may represent the amounts of various types of chemicals in a mixture of chemicals when the steady state was reached.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method, the method comprising:
identifying a set of concepts for a dynamic system, each concept having a dynamic state value for the dynamic system at a given point in time;
determining a state value for each concept at each of a set of time points;
generating, from the state values, an initial state and a system response;
designating the system response as an antigen in an artificial immune system clonal selection algorithm;
generating a set of candidate weight matrices to be used as a population of antibodies in the clonal selection algorithm, each candidate weight matrix including a set of weights which each represent the impact of a first respective concept on a second respective concept in the dynamic system;
determining a system response for each antibody, using the initial state;
determining an affinity value for each antibody, using the system response for the antibody, the affinity value for a respective antibody representing how closely the respective antibody fits the antigen;
cloning a set of antibodies based on the affinity values;
repeating the cloning until a stopping point is reached; and
selecting a candidate weight matrix with a highest affinity value for use in evaluating the dynamic system.

2. The method of claim 1, wherein cloning comprises:
determining the set of antibodies as antibodies that have highest affinity values;
cloning the set of antibodies to create a population of clones;
performing a clone maturation process on the population of clones to generate a population of matured clones;
determining an affinity value for each respective matured clone that represents how closely the respective matured clone fits the antigen;
determining a set of matured clones that have a relatively highest affinity values; and
replacing antibodies in the population of antibodies with the set of matured clones that have the relatively highest affinity values.

3. The method of claim 1, wherein the stopping point is reached when a candidate weight matrix has an affinity value that is greater than a predetermined threshold.

4. The method of claim 1, wherein the stopping point is reached when a predefined number of iterations have been performed.

5. The method of claim 1, wherein the stopping point is reached when a difference between highest affinity values between iterations is below a predefined threshold.

6. The method of claim 1, where determining the state values for each concept at each of the set of time points comprises observing the state values for each concept at each of the set of time points.

7. The method of claim 1, where determining the state values for each concept at each of the set of time points comprises retrieving stored data that includes the state values for each concept at each of the set of time points.

8. The method of claim 1, wherein the initial state comprises a set of initial state vectors and the system response comprises a set of system response vectors, each initial state vector being associated with a corresponding system response vector.

9. The method of claim 1, wherein the initial state comprises a single initial state vector and the system response comprises a single system response vector.

10. The method of claim 1, wherein the selected candidate weight matrix is used in a fuzzy cognitive mapping model when used for evaluation of the dynamic system.

11. The method of claim 1, wherein the set of candidate weight matrices is randomly generated.

12. The method of claim 1, wherein generating the set of candidate weight matrices comprises analyzing potential relationships among concepts using a set of one or more linear regression models.

13. The method of claim 1, wherein the set of one or more linear regression models includes a step-wise regression model.

14. A system, comprising:
at least one processor; and
a memory communicatively coupled to the at least one processor, the memory storing instructions which, when executed by the at least one processor, cause the at least one processor to perform operations comprising:
identifying a set of concepts for a dynamic system, each concept having a dynamic state value for the dynamic system at a given point in time;
determining a state value for each concept at each of a set of time points;
generating, from the state values, an initial state and a system response;
designating the system response as an antigen in an artificial immune system clonal selection algorithm;
generating a set of candidate weight matrices to be used as a population of antibodies in the clonal selection algorithm, each candidate weight matrix including a set of weights which each represent the impact of a first respective concept on a second respective concept in the dynamic system;
determining a system response for each antibody, using the initial state;
determining an affinity value for each antibody, using the system response for the antibody, the affinity value for a respective antibody representing how closely the respective antibody fits the antigen;
cloning a set of antibodies based on the affinity values;
repeating the cloning until a stopping point is reached; and
selecting a candidate weight matrix with a highest affinity value for use in evaluating the dynamic system.

15. The system of claim 14, wherein cloning comprises:
determining the set of antibodies as antibodies that have highest affinity values;
cloning the set of antibodies to create a population of clones;
performing a clone maturation process on the population of clones to generate a population of matured clones;
determining an affinity value for each respective matured clone that represents how closely the respective matured clone fits the antigen;
determining a set of matured clones that have a relatively highest affinity values; and
replacing antibodies in the population of antibodies with the set of matured clones that have the relatively highest affinity values.

16. The system of claim 14, wherein the stopping point is reached when a candidate weight matrix has an affinity value that is greater than a predetermined threshold.

17. The system of claim 14, wherein the stopping point is reached when a predefined number of iterations have been performed.

18. The system of claim 14, wherein the stopping point is reached when a difference between highest affinity values between iterations is below a predefined threshold.

19. One or more computer-readable media storing instructions which, when executed by at least one processor, cause the at least one processor to perform operations comprising:
identifying a set of concepts for a dynamic system, each concept having a dynamic state value for the dynamic system at a given point in time;
determining a state value for each concept at each of a set of time points;
generating, from the state values, an initial state and a system response;
designating the system response as an antigen in an artificial immune system clonal selection algorithm;
generating a set of candidate weight matrices to be used as a population of antibodies in the clonal selection algorithm, each candidate weight matrix including a set of weights which each represent the impact of a first respective concept on a second respective concept in the dynamic system;
determining a system response for each antibody, using the initial state;
determining an affinity value for each antibody, using the system response for the antibody, the affinity value for a respective antibody representing how closely the respective antibody fits the antigen;
cloning a set of antibodies based on the affinity values;
repeating the cloning until a stopping point is reached; and
selecting a candidate weight matrix with a highest affinity value for use in evaluating the dynamic system.

20. The computer-readable media of claim 19, wherein cloning comprises:
determining the set of antibodies as antibodies that have highest affinity values;
cloning the set of antibodies to create a population of clones;
performing a clone maturation process on the population of clones to generate a population of matured clones;
determining an affinity value for each respective matured clone that represents how closely the respective matured clone fits the antigen;
determining a set of matured clones that have a relatively highest affinity values; and
replacing antibodies in the population of antibodies with the set of matured clones that have the relatively highest affinity values.

21. The computer-readable media of claim 19, wherein the stopping point is reached when a candidate weight matrix has an affinity value that is greater than a predetermined threshold.

22. The computer-readable media of claim 19, wherein the stopping point is reached when a predefined number of iterations have been performed.
